(19) United States
(12) Patent Application Publication
(10) Pub. No.: US 2010/0007800 A1
(43) Pub. Date: Jan. 14, 2010

(54) Method for Managing a Viewing Set Comprising a Video Mixing Facility and a Cockpit Viewing System

(75) Inventor: Denis Bonnet, Bordeaux (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/495,422

(22) Filed: Jun. 30, 2009

(30) Foreign Application Priority Data
Jul. 4, 2008 (FR) 08 03817

(51) Int. Cl. H04N 9/67; G08B 21/00

(52) U.S. Cl. 348/659; 340/945; 348/E09.047

(57) ABSTRACT

The general field of the invention is that of methods for managing a cockpit viewing set comprising at least one video mixing facility, a cockpit viewing system, an interface for selecting the videos and a display screen. The method according to the invention relates to a method of generation by the cockpit viewing system of a graphical image comprising a display window comprising a video image. The main characteristic of this method is that the control of the video mixing facility is performed solely by the cockpit viewing system, the display instructions of the CDS coming from the selection interface. The method according to the invention is very suited to the protocols according to the ARINC 661 standard.

### PRIORITY CLAIM

This application claims priority to French Patent Application Number 08 03817, entitled Method for Managing a Viewing Set Comprising a Video Mixing Facility and a Cockpit Viewing System, filed on Jul. 4, 2008.

### BACKGROUND OF THE INVENTION

1. Field of the Invention

The field of the invention is that of aircraft cockpit viewing systems better known by the term CDS signifying “Cockpit Display System” and more particularly those having the capabilities to manage and to display video images.

2. Description of the Prior Art

For a few years now, new-generation aircraft have possessed a video system making it possible, by way of a video mixing facility termed VMF, to display on instrument panel viewing screens, video streams arising from several sources which may, for example, be cameras disposed inside or outside the craft. A mixing facility is preferably used so as to avoid having to develop video mixing resources in the CDS and more particularly in each of the screens. This service is thus centralized. The VMF merges the set of video streams that it is requested to merge into a single video stream of the size of the target screen, optionally provided with black areas corresponding to the portions of the screen on which no video stream is required. This video stream is thereafter displayed on one of the screens of the CDS as screen background.

In parallel with these advances, instrument panels are comprising fewer and fewer screens, the size of the screens being ever larger. To display the same quantity of information, “windows” are used. Thus, a single screen can comprise several display windows. In this type of cockpit, it is therefore necessary to display the video images in a coordinated manner, and sometimes in the form of windows.

The management of “Cockpit Display Systems” has formed the subject of a recent standard called ARINC 661 which defines and standardizes the definition of a CDS and the communications between the CDS and the exterior. This standard was adopted in 2001 and implemented, for example, in the development and industrialization of the Airbus A380. Reference may be made to the document entitled: “Cockpit Display System interface to User Systems” ARINC 661-2, AEEC/ARINC of 30 Jun. 2005 for all further information on this standard. The management method according to the invention applies most particularly within the framework of this ARINC standard.

More precisely, as indicated in FIG. 1, current CDS architectures are based on three main elements which are:
A Video Mixing Facility denoted VMF having several inputs and a video output, the inputs being hooked up by means of video buses B_{V} to video systems SV such as cameras;
An interface IF able to generate a video selection function F requesting the display of a particular video hooked up to the VMF and to the CDS by way of the aircraft bus B_{A};
A cockpit display system denoted CDS and having a video input hooked up to the VMF and outputs hooked up to the viewing screens E. This CUS is provided with a window manager, the main characteristic of which is to convert the coordinates of the man-machine interfaces which are addressed to it from relative coordinates (positioning in a window) to absolute coordinates (coordinates in a screen).

One of the tricky points with managing the display is illustrated in FIG. 2. The function F must ask the CDS to display its man machine interface in a window W but it does not control the positioning of this window W on the viewing screen E. The CDS alone controls this positioning, which varies as a function of the configuration of the system and actions of the operator, who could, for example, have repositioned this window. For example, in FIG. 2, the window W comprising the man-machine interface MMI and the video V is displayed a first time at the bottom of the screen and a second time at the top of the screen.

Hence, to display on a screen a video stream V in a window W comprising a Man-Machine Interface, the method currently used is the following:
The function F dispatches a first request to display a window W comprising the man-machine interface MMI and the location of a particular video to the CDS. This request, as was stated, is transmitted as relative coordinates;
The function F dispatches, in parallel, a second request to display the video to the VMF. This second request is transmitted as absolute coordinates;
The CDS executes the first request and determines the positioning of the window W (and therefore translates the relative coordinates into absolute coordinates) and displays the MMI thereon, video excluded;
The VMF executes the second request: it selects the chosen video stream, positions it so as to be consistent with the request of the function F and transmits it to the CDS;
The CDS receives the shaped video stream from the VMF and transmits it to the screen.

The main limitations of the current approach are the following:
Dependence between the function F and the CDS: The function F must know precisely the CDS windows positioning logic so as to be able to dispatch the video stream request in absolute coordinates;
Consistency: the two control chains not being synchronized, the resulting display may become inconsistent (transient display of the MMI without the video or of the video without the MMI);
Functionality: In the current architecture, the displacement of a window containing a video stream by the cursor in the CDS by means of the “drag/drop” functions is impossible since the CDS does not drive the positioning of the video.

### SUMMARY OF THE INVENTION

The aim of the invention is to provide an architecture capable of:
Allowing video display in windows;
Coordinating the display of these videos with that of the other elements of a man machine interface;
Simplifying the mixing facility;
Simplifying the system architecture and the topology of the network.

The proposed solution is based on the principle of making the CDS drive the VMF. The system architecture is different from that of the prior art in so far as the functional link between the function F and the VMF is broken. For ARINC 661 applications, the functions then dispatch MMI requests to the CDS which include the video aspect (identifier of the display zone, identifier of the video stream) by way of the object called “externalSource” according to the ARINC 661 standard.

More precisely, the subject of the invention is a method for managing a cockpit viewing set comprising at least one video mixing facility VMF, a cockpit viewing system CDS, an interface for selecting videos and a display screen, the video mixing facility being linked by a video bus to the cockpit viewing system and the interface for selecting videos being linked to the cockpit viewing system by an aircraft bus, characterized in that the generation, by the cockpit viewing system, of a graphical image comprising a display window containing a video image comprises the following steps:
The selection interface dispatches a request to display a window W comprising a man-machine interface MMI and the location of a video image V to the cockpit viewing system CDS, the coordinates of the interface and of the video image being defined as coordinates relative to the display window;
The cockpit viewing system CDS determines the graphical positioning of the window W, the man-machine interface and the display parameters of the video image on the display screen in absolute coordinates;
The cockpit viewing system CDS dispatches a request to display the said video image to the video mixing facility VMF in absolute coordinates with respect to the display screen;
The video m-nixing facility VMF selects the video image to be displayed, shapes it and positions it in absolute coordinates as a function of the request arising from the cockpit viewing system CDS and transmits it thereto;
The cockpit viewing system CDS receives the shaped video image and transmits it to the display screen. It is therefore positioned naturally in the display window W at the chosen location.

Advantageously, the display parameters comprise the definition of a video mask.

Preferably, when the dialogues between the video mixing facility VMF, the cockpit viewing system CDS and the interface for selecting videos are performed according to the “ARINC 661” aeronautical standard, the MMI display requests including the video aspect are performed by way of the object called “externalSource” according to the ARINC 661 standard.

Moreover, when the cockpit viewing system CDS dispatches a request to display a video image to the video mixing facility VMF, it also dispatches a unique identifier specific to the said request and when the video mixing facility VMF transmits the said video image to the cockpit viewing system, the said identifier is also retransmitted.

Finally, the system guarantees the display of the mall machine interface before the display of the video. Thus, as long as the video image is not transmitted by the video mixing facility VMF to the cockpit viewing system CDS, the latter displays a predefined item of information at the chosen location.

### BRIEF DESCRIPTION OF THE DRAWINGS

The invention will be better understood and other advantages will become apparent on reading the nonlimiting description which follows and by virtue of the appended figures among which:

FIG. 1 represents an instrument panel comprising 8 VDUs;

FIG. 2 represents the chart of the configuration method according to the invention;

FIG. 3 represents a partial view of a VDU set making it possible to display several formats;

FIG. 4 represents the new steps of the method according to the invention.

### MORE DETAILED DESCRIPTION

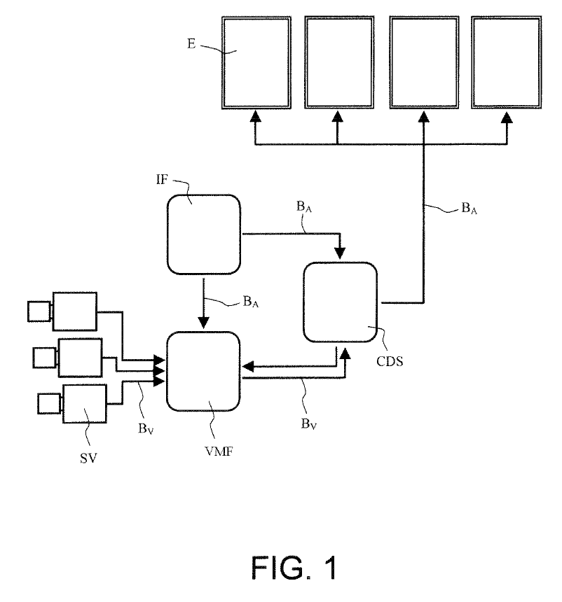

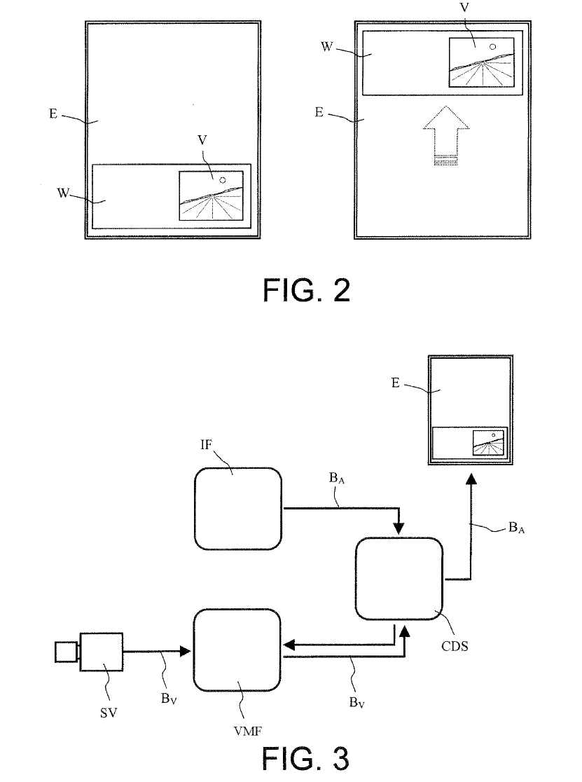

FIG. 3 represents the whole of the viewing device implementing the method for managing the video streams according to the invention. It essentially comprises a Video Mixing Facility having several inputs hooked up by means of video buses to video systems such as cameras and a video output, a cockpit display system denoted CDS and having a video input hooked up to the VMF and outputs hooked up to the viewing screens and an interface which is able to generate a video selection function F requesting the display of a particular video hooked up to the CDS by way of the aircraft bus. As seen, the essential difference between this device and that of the prior art such as depicted in FIG. 1 is that it does not require any linkup between the selection interface and the video mixing facility.

The method according to the invention comprises five main steps which are detailed below. The method can apply to various types of aeronautical standards. In what follows, the various examples of implementations are established according to the ARINC 661 standard.

In a first step, the selection interface dispatches a request to display a window W comprising a man-machine interface MMI and the location of a video image V to the cockpit viewing system CDS. When working with ARINC 661, the request asks for the display of the object denoted “externalSource”. This object refers to a video stream through a unique identifier (source reference parameter of ARINC 661). The objective of the externalSource object of ARINC 661 is initially, within the framework of the standard, to manage several video streams entering a CDS. Now, ill the case of the use of a VMF, the CDS has only one input and the object seems useless. In the method according to the invention, a system extension of the notion of “externalSource” is therefore used by using the object not to directly drive the videos entering the CDS but to drive the VMF remotely.

In a second step, the cockpit viewing system CDS determines the graphical positioning of the window W, the man-machine interface and the display parameters of the video image on the display screen. To display the video, the CDS defines the zone in which this video must be displayed by identifying a set of rectangles with coordinates (Xᵢ, Yᵢ, Wᵢ, Hᵢ), identifies the destination of the video on the screen (X, Y, W, H) and implements the mechanisms making it possible to display the video stream thereon, namely the definition of a “video mask”.

In ARINC 661, the CDS extracts the following information from tile “externalSource” object:
The coordinates (X, Y) and the size (H, L) of the zone in which the video must be displayed;
The geometric transformations which must be applied to the video entering the VMF (rotation, homothety, translation, etc.);
The identifier of the video stream.

In a third step, the cockpit viewing system CDS dispatches a request to display the said video image to the video mixing facility VMF.

In a fourth step, the video mixing facility VMF selects the video image to be displayed, shapes it and positions it as a function of the request arising from the cockpit viewing system and transmits it thereto. The main tasks of the VMF are to mix and to process several incoming videos so as to produce a resulting video dispatched to the client screens of the CDS. The operations conventionally supported by a VMF are:
For each video flow: repositioning, rotation and redimensioning;
The mixing of the processed video flows so as to build the resulting image.

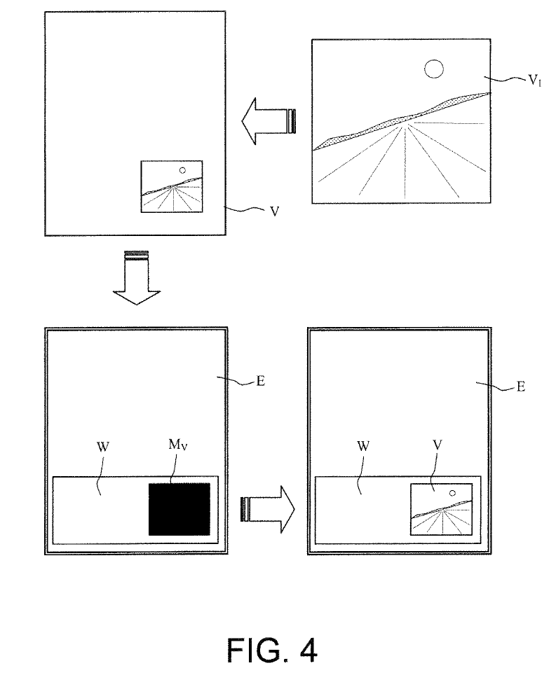

In a fifth step, the cockpit viewing system CDS receives the video image shaped by the VMF and transmits it to the display screen in the display window W at the chosen location. The video arising from the VMF is then displayed in the place of the previously identified rectangles. For example, if the initial display of the “video mask” is a rectangle of a specific colour, each initial pixel of this rectangle is replaced with the equivalent pixel of the video, the so-called “chroma key” principle. In a real implementation, the resulting video is often of the size of the video mask, the remainder of the video being black. Indeed, most of the time, the VMF reduces the size of the video V, the functional objective of the whole system being to display the whole of the image entering the VMF in the associated video mask M_{V} of the CDS. This is illustrated in FIG. 4 which shows the four steps of inlaying a video V on a screen E: Acquisition of the video V₁ by the VMF, followed by reduction and shaping of the video V by the VMF, dispatching to the CDS of the video and inlaying instead of the video mask on the screen E.

The mechanism for displaying video in a CDS can be applied in the same manner in the case of several videos entering the VMF. In this case, the VMF constructs a composite image which is thereafter displayed at the location of the video masks. This mechanism operates in exactly the same manner in the case where several videos potentially associated with several functions must be displayed: each function requests the display of its “externalSource” object(s). The CDS then transmits the requests for the various video flows to the VMF, which then mixes all these sources.

There moreover exists a latency between the request of a video display issued to the VMF and the display of this stream on the screen. This latency is due to:
The duration of the communication between the CDS and the VMF (for the video request)
The duration of processing of the VMF (selection of the stream, positioning on the screen and mixing to obtain the resulting video)
The latency of the communication between the VMF and the CDS (oil the video bus)
The duration of synchronization and processing of the video by the CDS.

Thus, for a certain duration, the CDS toggles into a mode where a video must be displayed but no signal is specifically received or, if a signal is available, it corresponds to an obsolete video configuration. It is therefore necessary to determine whether the video received does indeed correspond to the request made and to manage the standby while awaiting this video.

In the case of the use of ARINC 661, the first problem is handled with an identifier principle and by using the ARINC 818 video protocol (see in this regard: Avionics Digital Video Bus—High Data Rate ARINC 518 draft 4, AEEC/ARINC, 1 Aug. 2006). When dispatching the video request to the VMF, the CDS dispatches a unique identifier to the VMF which can be a serial number incremented on each new request. When the request has been taken into account by the VMF and the requested video is therefore produced, the identifier is returned to the CDS in the ARINC 818 video frame. The CDS can therefore display it while being certain of its relevance.

The solution to the second problem is based on the processing of the externalSource. As long as the requested video is not available, the CUS displays in the video zone a predefined item of information which can be a black rectangle, a message, a progress bar, etc. When the video is available, the unique identifier is received in the ARINC 818 frame, it is immediately displayed by replacing the predefined item of information by a video mask. More generally, the identifier of the video request can be used at each cycle to be certain of the consistency between the configuration of the video masks of the CDS and that of the outputs of the VMF.

In conclusion, this method exhibits the following advantages:
Renders the VMF and the CDS independent: the VMF need not know the CDS windows positioning strategy;
Improves consistency: the CDS receiving the whole of the MMI display request (video included), it can therefore synchronize the set (and for example display a message in the video zone as long as the signal is not available);
Affords new functionalities: In the case of a displacement function called “drag/drop” managed by a graphical designator of “mouse” type, the CDS issues, on each displacement, the new coordinates of the video to the VMF, which can then modify the video stream;
Simplifies the video mixing facility;
Simplifies the system architecture, the selection functions need no longer be connected directly to the VMF, they can simply use the existing connection to the CDS.

What is claimed is:

1. Method for managing a cockpit viewing set comprising at least one video mixing facility, a cockpit viewing system, an interface for selecting videos and a display screen, the video mixing facility being linked by a video bus to the cockpit viewing system and the interface for selecting videos being linked to the cockpit viewing system by an aircraft bus, wherein the generation, by the cockpit viewing system, of a graphical image comprising a display window containing a video image comprises the following steps:
The selection interface dispatches a request to display a window comprising a man-machine interface and the location of a video image to the cockpit viewing system, the coordinates of the interface and of the video image being defined as coordinates relative to the display window;
The cockpit viewing system determines the graphical positioning of the window, the man-machine interface and the display parameters of the video image on the display screen in absolute coordinates with respect to the display screen;
The cockpit viewing system dispatches a request to display the said video image to the video mixing facility in absolute coordinates;
The video mixing facility selects the video image to be displayed, shapes it and positions it in absolute coordinates as a function of the request arising from the cockpit viewing system and transmits it thereto;
The cockpit viewing system receives the shaped video image and transmits it to the display screen in the display window at the chosen location.

2. Method for managing a cockpit viewing set according to claim 1, wherein the display parameters comprise the definition of a video mask.

3. Method for managing a cockpit viewing set according to claim 1, wherein, when the dialogues between the video mixing facility, the cockpit viewing system and the interface for selecting videos are performed according to the “ARINC 661” aeronautical standard, the MMI display requests including the video aspect are performed by way of the object called “externalSource” according to the ARINC 661 standard.

4. Method for managing a cockpit viewing set according to claim 1, wherein, when the cockpit viewing system dispatches a request to display a video image to the video mixing facility, it also dispatches a unique identifier specific to the said request and when the video mixing facility transmits the said video image to the cockpit viewing system, the said identifier is also retransmitted.

5. Method for managing a cockpit viewing set according to claim 1, wherein, as long as the video image is not transmitted by the video mixing facility to the cockpit viewing system, the latter displays a predefined item of information at the chosen location.
